(19) United States
(12) Patent Application Publication
(10) Pub. No.: US 2008/0016731 A1
(43) Pub. Date: Jan. 24, 2008

(54) Lyrically speaking

(76) Inventor: Sharen Branch, New Windsor, NY (US)

Correspondence Address: Sharen Branch, 55 Cedar Avenue, New Windsor, NY, 12553, US

(21) Appl. No.: 11/472,074

(22) Filed: Jun. 22, 2006

(51) Int. Cl. G09F 1/00

(52) U.S. Cl. 40/124.03

(57) ABSTRACT

This invention provides a unique greeting card that uses the lyrics of all genres of music. The card will compromise of titles of song as well as the lyrics. This present invention will combine the greeting card sentiment with the use of copy written, popular, lyrics and/or music sound device. The present invention provides a new novel commercial licensed product for lyricist and musicians. Everybody has a song to sing. It will be used to celebrate all the traditional holidays and create a new way to share greetings and music.

### BACKGROUND OF THE INVENTION

### Field of the Invention

This invention relates generally to the field of apparatus for a greeting card which will express the traditional greeting card sentiments with added feature of lyrics and/or sound byte of copy written, popular, music and lyrics of all genres. Moreover it pertains specifically to such apparatus for a greeting card when opened will express the traditional greeting card sentiment with the use of copy written, popular, lyrics and/or music sound device. Music of all genres. The card consist of paper, printed artwork, copy written, popular, lyrics and/or music sound device. Royalty fees will be paid where applicable. The card will vary in size, and use copy written, popular, lyrics. A music sound device will play the tune of song. Greeting card will be varying in size depending on printed matter. Interior of card will be lyrics and expressed sentiment. Back of the card will be stylized with symbol of old phonograph that contains company logo, song credit and secondary logo.

The greeting card market exists to provide an avenue for individuals to express various emotions to others. Cards themselves do not typically present the recipient with more than a written message, and as such can fall short of the givers intended expression. Music is another well recognized mode for expression of feeling and emotion. Previously music has not been well utilized in combination with greeting cards. Greeting cards have been produced in the past with various musical greeting using small pre-programmed electronic units built into card body. The card purchaser has little or no choice of music and verse. The card may be used as a licensed commercial item, new medium, novelty, mementos and collectors items. The card may or may not contain a music sound device. The card can also be used as a promotional and/or marketing tool for lyricist and musicians.

### SUMMARY OF THE INVENTION

In view of the limitations now present in the prior art, the present invention provides a new and useful greeting card which will express the traditional greeting card sentiments with added feature of lyric and/or sound byte of copy written, popular, lyrics and music of all genres, which is simpler in construction, more universally usable and more versatile in operation than known apparatus of this kind.

The purpose of the present invention is to provide a new greeting card which will express the traditional greeting card sentiments with added feature of lyric and/or sound byte of copy written, popular, lyrics and music of all genres, a device that has many novel features not offered by the prior art apparatus that result in a new greeting card which will express the traditional greeting card sentiments with added feature of lyric and/or sound byte of copy written, popular, lyrics and music of all genres, which is not apparent, obvious, or suggested, either directly or indirectly by any of the prior art apparatus for a greeting card when opened will express the traditional greeting card sentiment with the use of copy written, popular, lyrics and/or music sound device. Music of all genres. The card consist of paper, printed artwork, copy written, popular, lyrics and/or music sound device. Royalty fees will be paid where applicable. The card will vary in size, and use copy written, popular, lyrics. A music sound device will play the tune of song. Greeting card will be varying in size depending on printed matter. Interior of card will be lyrics and expressed sentiment. Back of the card will be stylized with symbol of old phonograph that contains company logo, song credit and secondary logo.

The greeting card market exists to provide an avenue for individuals to express various emotions to others. Cards themselves do not typically present the recipient with more than a written message, and as such can fall short of the givers intended expression. Music is another well recognized mode for expression of feeling and emotion. Previously music has not been well utilized in combination with greeting cards. Greeting cards have been produced in the past with various musical greeting using small pre-programmed electronic units built into card body. The card purchaser has little or no choice of music and verse. The card may be used as a licensed commercial item, new medium, novelty, mementos and collectors items. The card may or may not contain a music sound device. The card can also be used as a promotional and/or marketing tool for lyricist and musicians.

The foregoing has outlined, in general, the physical aspects of the invention and is to serve as an aid to better understanding the more complete detailed description which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### OBJECTS OF THE INVENTION

Accordingly several advantages and objects of the present invention are:

A principal object of the present invention is to provide a useful greeting card which will express the traditional greeting card sentiments with added feature of lyric and/or sound byte of copy written, popular, music and lyrics of all genres that will overcome the deficiencies of the prior art devices.

An object of the present invention is to provide a greeting card which will express the traditional greeting card sentiments with added feature of lyric and/or sound byte of copy written, popular, lyrics and music of all genres, a device that functions as a traditional greeting card that will express traditional greeting card sentiment with optional feature of musical sound device. The method of creating a card that uses copy written, popular lyrics and/or music sound device. Music of all genres.

Another object of the present invention is to provide a greeting card which will express the traditional greeting card sentiments with added feature of lyric and/or sound byte of copy written, popular, lyrics and music of all genres device that the front of card will feature intended expressed sentiment utilizing title or part of song.

Another object of the present invention is to provide a greeting card which will express the traditional greeting card sentiments with added feature of lyric and/or sound byte of copy written, popular, lyrics and music of all genres a device that inside of card will have the excerpt of lyrics and expressed sentiment.

Another object of the present invention is to provide a greeting card which will express the traditional greeting card sentiments with added feature of lyric and/or sound byte of copy written, popular, lyrics and music of all genres a device that the back of card will be stylized with symbol of old phonograph that contains company logo, song credit and secondary logo.

Another object of the present invention is to provide a greeting card which will express the traditional greeting card sentiments with added feature of lyric and/or sound byte of copy written, popular, lyrics and music of all genres a device that will have an optional feature inside that will have small pre-programmed music sound device built into the card body.

Another object of the present invention is to provide a greeting card which will express the traditional greeting card sentiments with added feature of lyric and/or sound byte of copy written, popular, lyrics and music of all genres, a device that royalties will be paid.

Another object of the present invention is to provide a greeting card which will express the traditional greeting card sentiments with added feature of lyric and/or sound byte of copy written, popular, lyrics and music of all genres a card that may or may not have optional feature inside.

It is intended that any other advantages and objects of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1. is an open view of a greeting card which will express the traditional greeting card sentiments with added feature of lyric and/or sound byte of copy written, popular, lyrics and music of all genres, according to the present invention. This view includes an ideal placement for the sound module.

FIG. 2. is a rear view of a greeting card which will express the traditional greeting card sentiments with added feature of lyric and/or sound byte of copy written, popular, lyrics and music of all genres, according to the present invention according to the present invention. The rear of the card will show and be stylized as an old phonograph that will contain company logo, song credit, secondary logo, patent pending, etc.

FIG. 3. is an interior left sided view of a greeting card which will express the traditional greeting card sentiments with added feature of lyric and/or sound byte of copy written, popular, lyrics and music of all genres, according to the present invention. Lyrics and/or sentiment may be placed here.

FIG. 4. is an interior right view of a greeting card greeting card which will express the traditional greeting card sentiments with added feature of lyric and/or sound byte of copy written, popular, lyrics and music of all genres, according to the present invention. Here lyrics and/or sentiment may be placed.

FIG. 5. is a closed front view of greeting card which will express the traditional greeting card sentiments with added feature of lyric and/or sound byte of copy written, popular, lyrics and music of all genres, according to the present invention. Here lyrics, sentiments or greetings may be placed.

### DETAILED DESCRIPTION OF THE INVENTION

Referring now descriptively to the drawings, the attached figures illustrates a greeting card which will express the traditional greeting card sentiments with added feature of lyric and/or sound byte of copy written, popular, lyrics and music of all genres, according to the present invention a “Lyrically Speaking” musical greeting card.

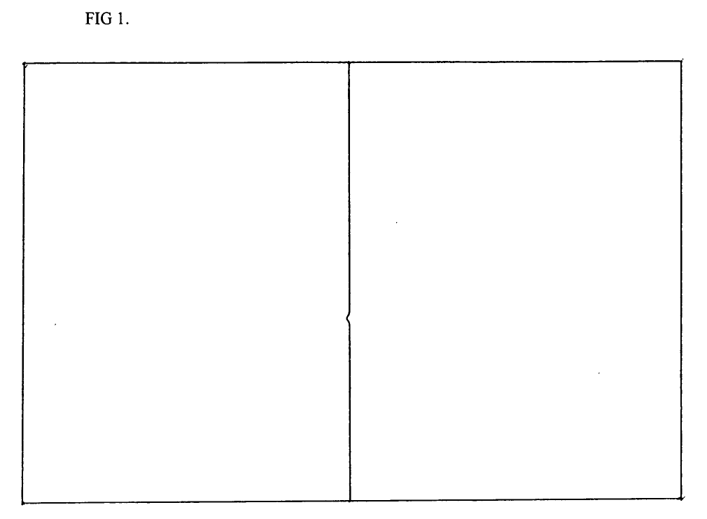

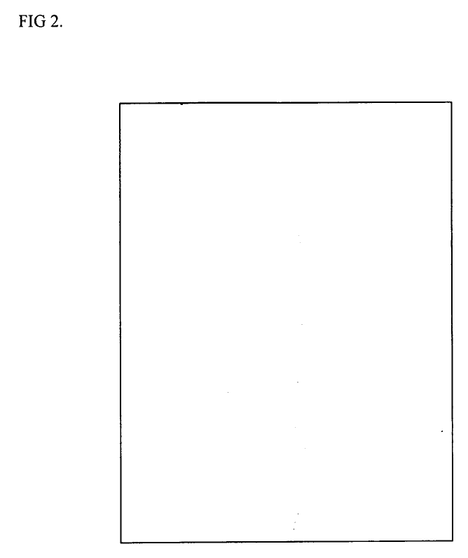

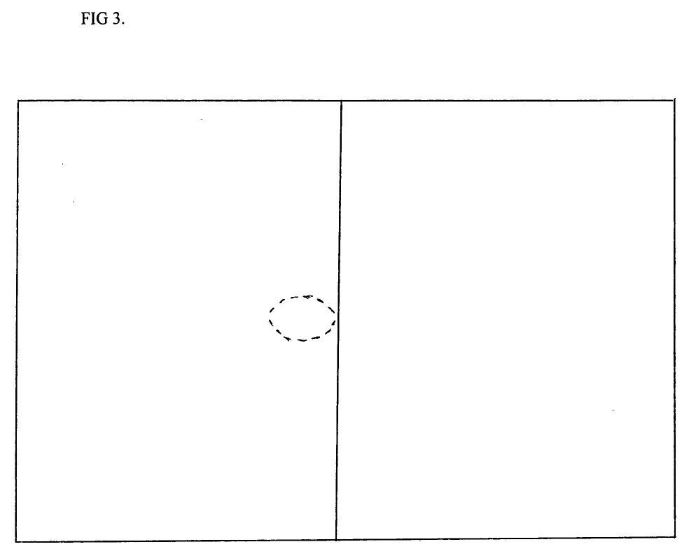

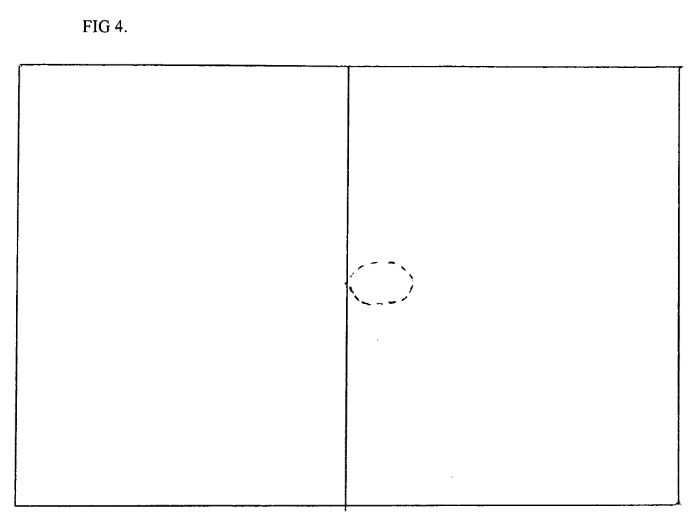

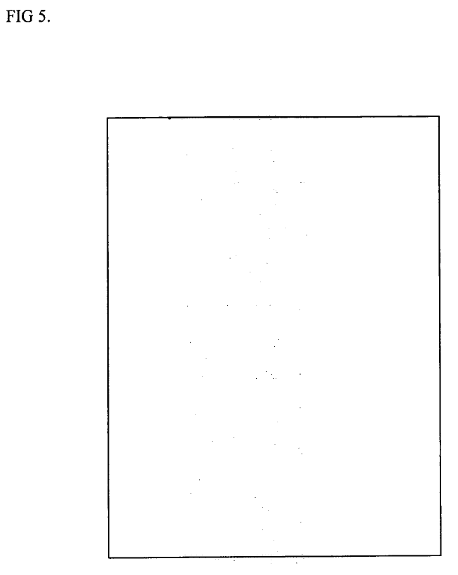

FIGS. 1 through 5 illustrates a greeting card which will express the traditional greeting card sentiments with added feature of lyric and/or sound byte of copy written, popular, lyrics and music of all genres, according to the present invention.

This invention relates to greeting cards when opened or cued will express the traditional greeting card sentiment with the use of copy written, popular, lyrics and/or music sound device. Music of all genres will be utilized in the making of the card. The card consist of paper, printed artwork, copy written, popular, lyrics and/or music sound device. Royalty fees will be paid where applicable. The card will vary in size, and use copy written, popular, lyrics. A music sound device will play the tune of song and lyrics. Greeting card will be varying in size depending on printed matter. Interior of card will be lyrics and expressed sentiment. Back of the card will be stylized with symbol of old phonograph that contains company logo, song credit and secondary logo.

The “Lyrically Speaking” greeting card is an unique, unobvious, basic greeting card that uses copy written, popular, lyrics and/or music sound bytes of all genres as its greetings. Greetings that will express the traditional greeting card sentiments with the added feature of lyrics, and or sound byte of copy written, popular, music and lyrics of all genres. Cards will vary in size depending on printed matter. The interior of the card will be the standard format of a music sheet containing copy written, popular, lyrics and/or music sound bytes of all genres. The rear of card will be stylized as an old phonograph record that may contain; company logo, song credits, secondary logo, etc.

The card may or may not carry mechanical sound device. Card will be designed in various sizes as well as shapes. The card may be used as a novelty, momentum and/or collectors item on all printed matter. The card can also be used as a promotional tool for lyricist and musicians.

It will also be understood that, in addition to being the greeting card which will express the traditional greeting card sentiments with the added feature of lyrics and/or sound bytes of copy written, popular, music and lyrics of all genres, the device can be used as a promotional tool for lyricist, musicians, companies and others looking for marketing tools. The card may also be used as a novelty item, momentum and or a collector item.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

### BACKGROUND OF THE INVENTION

### Description of Related Art

Many devices have been proposed for a greeting card. Some of these devices are found in U.S. Pat. No. 4,102,067 issued to Fred Tarrant et al. on Jul. 25, 1978, U.S. Pat. No. 3,462,157 issued to E. R. Barnett et al. on Aug. 19, 1969, U.S. Pat. No. 5,915,734 issued to Mineheart on Jun. 29, 1999. However, these devices are limited in their functionality, all by (1) not relying on the actual aspect of using copy written, popular music to create the greeting cards sentiment (2) offering royalties to the various artists and musicians of all genres and popularities (3) by not incorporating the actual song lyrics into the cards body as the actual sentiment or greeting. In each of the aforementioned patents there are no mentions of types of music being utilized, in U.S. Pat. No. 3,462,157 issued to E. R. Burnett et al. on Aug. 19, 1969 there was no mention of the importance or improvement of using copy written, popular, music and lyrics and/or music sound bytes of all genres.

Each previous patent did not combine the two most important aspects of greeting cards, the type of sentiment and the delivery system. U.S. Pat. No. 5,915,734 issued to Mineheart on Jun. 29, 1999 mentioned a sound recording device but did not include any relation to the type of music or genre, there's no mention of popular music and or copy written music. This falls short of the goal of delivering a total sentiment.

1. A principal claim of the present invention is to provide a useful greeting card which will express the traditional greeting card sentiments with added feature of lyric and/or sound byte of copy written, popular, music and lyrics of all genres that will overcome the deficiencies of the prior art devices.
A claim of the present invention is to provide a greeting card which will express the traditional greeting card sentiments with added feature of lyric and/or sound byte of copy written, popular, lyrics and music of all genres, a device that functions as a traditional greeting card that will express traditional greeting card sentiment with optional feature of musical sound device. The method of creating a card that uses copy written, popular lyrics and /or music sound device. Music of all genres.
Another claim of the present invention is to provide a greeting card which will express the traditional greeting card sentiments with added feature of lyric and/or sound byte of copy written, popular, lyrics and music of all genres device that the front of card will feature intended expressed sentiment utilizing title or part of song.
Another claim of the present invention is to provide a greeting card which will express the traditional greeting card sentiments with added feature of lyric and/or sound byte of copy written, popular, lyrics and music of all genres a device that inside of card will have the excerpt of lyrics and expressed sentiment.
Another claim of the present invention is to provide a greeting card which will express the traditional greeting card sentiments with added feature of lyric and/or sound byte of copy written, popular, lyrics and music of all genres a device that the back of card will be stylized with symbol of old phonograph that contains company logo, song credit and secondary logo.
Another claim of the present invention is to provide a greeting card which will express the traditional greeting card sentiments with added feature of lyric and/or sound byte of copy written, popular, lyrics and music of all genres a device that will have an optional feature inside that will have small pre-programmed music sound device built into the card body.
Another claim of the present invention is to provide a greeting card which will express the traditional greeting card sentiments with added feature of lyric and/or sound byte of copy written, popular, lyrics and music of all genres, a device that royalties will be paid.
Another claim of the present invention is to provide a greeting card which will express the traditional greeting card sentiments with added feature of lyric and/or sound byte of copy written, popular, lyrics and music of all genres a card that may or may not have optional feature inside
It is intended that any other advantages and claims of the present invention that become apparent or obvious from the detailed description or illustrations contained herein are within the scope of the present invention.
